(19) United States
(12) Patent Application Publication
(10) Pub. No.: US 2015/0323948 A1
(43) Pub. Date: Nov. 12, 2015

(54) SYSTEM FOR ANALYZING BUILDING ENERGY CONSUMPTION INFORMATION

(71) Applicant: Electronics and Telecommunications Research Institute, Daejeon (KR)

(72) Inventors: Youn-Kwae JEONG, Daejeon (KR); Il-Woo LEE, Daejeon (KR)

(21) Appl. No.: 14/550,532

(22) Filed: Nov. 21, 2014

(30) Foreign Application Priority Data
May 8, 2014 (KR) 10-2014-0055073

(51) Int. Cl. G05F 1/66; G05B 15/02

(52) U.S. Cl. CPC G05F 1/66; G05B 15/02

(57) ABSTRACT

The present invention relates to a system for analyzing building energy consumption and particularly to a web-based system for remotely analyzing building energy consumption information in real time that can remotely collect and store building attribute information, facility operation and status information, energy consumption information, environment information and real-time commissioning information and the like of a plurality of buildings in real time, provide and manage various services for energy efficiency improvement based on such information, generate building energy efficiency improvement plans (actions) automatically by performing services according to a manager's selection and using inference devices based on the execution result to optimize energy consumption and efficiency of a building and energy facilities.

### CROSS-REFERENCE TO RELATED APPLICATIONS

This application claims the benefit of Korean Patent Application No. 10-2014-0055073, filed with the Korean Intellectual Property Office on May 8, 2014, the disclosure of which is incorporated herein by reference in its entirety.

### BACKGROUND

1. Technical Field

The present invention relates to a system for analyzing building energy consumption information, more specifically to a web-based system for remotely analyzing building energy consumption information in real time that can optimize energy consumption and efficiency of a building and energy facilities by remotely collecting, storing and managing real-time attribute information, facility operation and status information, energy consumption information, environment information and commissioning information for a plurality of buildings and performing a building attribute profile management service, a demand control/policy management service, a consumption information statistics analysis service, a building benchmarking service, a consumption factor analysis service, an energy consumption prediction service, a performance outcome difference analysis service, a facility efficiency analysis service and a web service according to a service request made by a manager.

2. Background Art

A recent energy consumption analysis function usually provides a simple report such as graphs or tables of statistical information, including building energy facility operation information and status information, facility efficiency information, energy consumption information, building attribute information and the like provided by building automation system (BAS)/building energy management server (BEMS), through various user environments. A building energy manager analyzes and manages for energy efficiency of a building and facilities therein according to manager's experiences and judgments made based on such statistical information.

However, this method can not only deal with one building but also require complicate analysis processes and a long period of time for the analysis. Further, it results in lack of accuracy and reliability in energy efficiency improvement of a building, so that it is difficult to obtain continuous and effective energy savings in the building management.

Accordingly, there is demand for developing a system for analyzing building energy consumption which can save building energy management costs and provide building energy consumption improvement plans by collecting and analyzing building attribute information, facility operation and status information, energy consumption information, environment information and real-time commissioning information for a plurality of buildings in real time; and providing various remote web-based building energy consumption information analysis services such as building attribute profile management, demand control and policy management, consumption information statistics analysis, benchmarking, consumption factor analysis, consumption prediction, outcome analysis, facility efficiency analysis for an energy manager to improve continuously and effectively energy efficiency of the building and facilities based on the information.

### SUMMARY OF THE INVENTION

An object of the present invention is to provide environment for a manager to effectively improve building energy efficiency by collecting building attribute information, facility operation/status information, energy consumption information, environment information and real-time commissioning information for a plurality of remote buildings and building DB; and providing various building energy consumption information analysis services such as building attribute profile management, demand control and policy management, consumption information statistics analysis, benchmarking, consumption factor analysis, consumption prediction, outcome analysis, facility efficiency analysis and the like based on the information by a building energy manager in a remote building energy control center.

Another object of the present invention is to save energy of a building through savings in building energy management cost and continuous improvement and management in energy efficiency of the building and facilities not only by providing a function to directly conduct a service among a variety of building energy analysis services as needed by a manager or repeatedly conduct a predetermined service composition and then visualize the result of the conducted service as a table, a figure or a graph but also by producing and readily and effectively providing energy conservation measure (ECM, energy improvement plan/energy improvement measure) to improve efficiency through an inference device providing an improvement plan based on the result of the conducted services to the manager.

A system for analyzing building energy consumption according to an embodiment of the present invention may include: a building energy information generating device generating building energy-related information by being installed in each of a plurality of buildings which are to be controlled; a building energy information collecting device collecting the energy-related information generated by the building energy information generating device in real-time; an energy information storing device receiving building attribute information and the building energy-related information collected by the building energy information collecting device and storing it on a building and information type basis; an energy consumption analysis service device providing an energy consumption analysis service for the building based on the building energy-related information and the building attribute information stored in the energy information storing device; and a real-time energy efficiency plan providing device providing an energy efficiency improvement plan for the building in real-time based on the energy consumption analysis service result.

The system for analyzing building energy consumption according to an embodiment of the present invention is able to provide a building energy improvement plan in real time to the manager, in which the building energy improvement plan is produced by executing various service modules according to a service request made by a manager. The system for analyzing building energy consumption according to an embodiment of the present invention is also able to improve energy efficiency and save energy by not only generating an improvement plan made through manager's judgment and experience-based analysis of the service result but also generating automatically an improvement plan according to the result through the inference device.

The system for analyzing building energy consumption according to an embodiment of the present invention is further able to provide energy consumption analysis for a plurality of remote buildings through a web server, which allows that one consumption analysis center can manage a plurality of buildings to increase efficiency and economical efficiency.

The system for analyzing building energy consumption according to an embodiment of the present invention is further able for a control center to control various services, so that new services which are suitable for each building's characteristics can be controlled easily to improve energy efficiency of buildings.

The system for analyzing building energy consumption according to an embodiment of the present invention further allows integrated collecting and managing energy data for a remote building to asses energy consumption information of another building located in the outside of a control center (for example, National building energy integrated management system) to use for various services of the system for analyzing building energy consumption. The system for analyzing building energy consumption according to an embodiment of the present invention provides a real-time energy efficiency improvement plan effectively through various analysis services for a plurality of buildings to increase accuracy and ability of consumption information analysis with low cost and significantly improve energy efficiency and continuous energy savings of the building and facilities thereof.

### BRIEF DESCRIPTION OF THE DRAWINGS

FIG. 1 is a block view illustrating a system for analyzing building energy consumption according to an embodiment of the present invention.

FIG. 2 is a flowchart illustrating a process for providing building energy consumption analysis services according to an embodiment of the present invention.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

Unless clearly used otherwise, expressions in the singular number include a plural meaning.

In the present description, expressions such as “module”, “part”, “interface” and the like generally mean computer-related objects such as hardware, software and its combination.

The present invention will be described below in more detail with reference to the accompanying drawings.

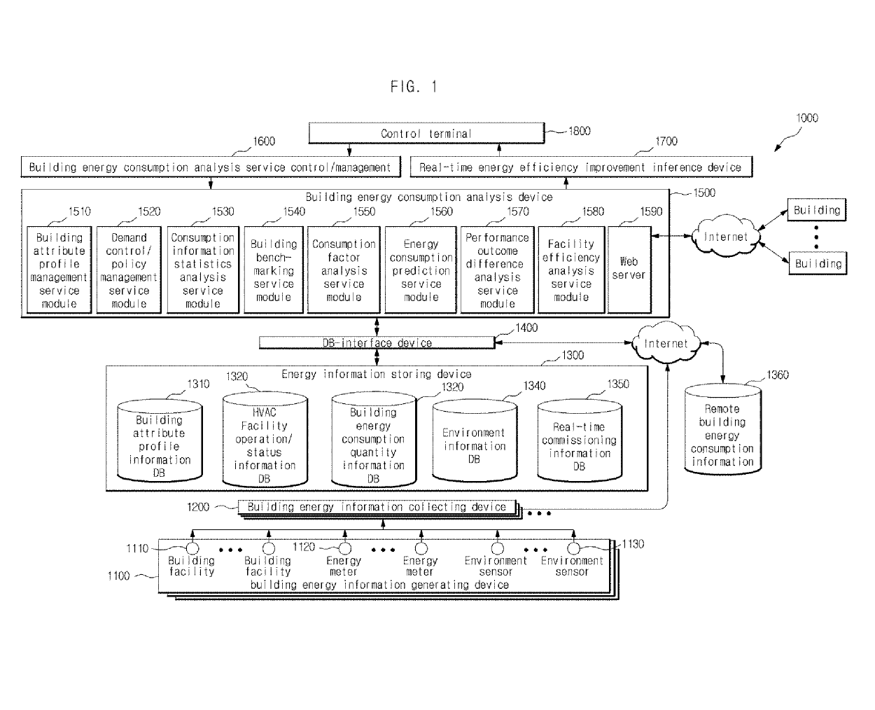

FIG. 1 is a block view illustrating a system for analyzing building energy consumption according to an embodiment of the present invention.

A system for analyzing building energy consumption according to an embodiment of the present invention 1000 may include a building energy information generating device 1100, a building energy information collecting device 1200, a building energy information storing device 1300, a DB interface device 1400, a building energy consumption analysis device 1500, a building energy consumption analysis service control/management device 1600, a real-time energy efficiency improvement plan providing device 1700 and a control terminal 1800.

In an embodiment, the building energy information generating device 1100 generates building energy-related information in real time by being installed in each building to be controlled. The building energy information generating device 1100 may include an energy-consuming facility 1100 such as heating, ventilation and air conditioning (HVAC) and lighting, an energy meter 1120, an environment sensor 1130 and the like.

The building energy information collecting device 1200 collects in real time building energy-related information generated by the building energy information generating device 1100, for example, operation/status information generated by the HVAC facilities 1100, energy metering information (e.g., electricity, gas, water, oil, flux, air volume and the like) measured by the energy meter 1120 and environment sensor information (e.g., temperature, humidity, pressure, vibration, brightness, occupancy and the like) generated by the environment sensor 1130 and then transmits it to the building energy information storing device 1300 through internet and the DB interface device 1400.

The building energy information storing device 1300 has a structure including a plurality of databases storing the building energy-related information received from the building energy information collecting device 1200 and other information necessary for building energy consumption analyses by building type and by information type. For example, the building energy information storing device 1300 may include a building attribute profile information DB 1310, a HVAC facility operation/status information DB 1320, a building energy consumption quantity information DB 1330, an environment information DB 1340, a real-time commissioning information DB 1350 and the like.

The building attribute profile information DB 1310 stores building attribute information inputted from a building energy manager or generated by the system 1000, such as location, size, purpose, energy source, and facility information, energy consumption quantity information of a building, precipitation, solar radiation, weather, occupant and the like.

Operation and status information which is generated by the HVAC facilities 1110 installed in a corresponding building may be collected in real time by the building energy information collecting device 1200 and stored in the HVAC facility operation/status information DB 1320.

Energy consumption quantity (electricity, gas, oil and the like) information measured by the energy meter 1120 installed in a corresponding building may be collected in real time by the building energy information collecting device 1200 and stored in the energy consumption quantity information DB 1330.

Environment information (temperature, humidity, brightness, occupancy and the like) measured by the environment sensor 1130 which is installed to determine space conditions of a corresponding building may be collected in real time by the building energy information collecting device 1200 and stored in the environment information DB 1340.

Real-time commissioning information measured by an energy meter (flux, oil pressure, air volume and the like) and an environment sensor (temperature, humidity, pressure, vibration and the like) which are installed to determine real-time operation efficacy for each HVAC facilities 1110 installed in a corresponding building may be collected in real time by the building energy data collecting device 1200 and stored in the real-time commissioning information DB 1350.

The DB interface device 1400 may obtain building energy-related information which is necessary to execute service modules (1510 to 1580) of the analysis device 1500 from the energy information storing device 1300 or obtain information which is necessary for comparative analyses of energy by being coupled to a remote building energy consumption information system 1360 (e.g., National integrated building energy management system) which is located in the outside, through internet.

The building energy consumption analysis device 1500 may include a plurality of service modules which provide various services for building energy consumption diagnosis. In an embodiment, the analysis device 1500 may include at least one of a building attribute profile management service module 1510, a demand control/policy management service module 1520, a consumption information statistics analysis service module 1530, a building benchmarking service module 1540, a consumption factor analysis service module 1550, an energy consumption prediction service module 1560, a performance outcome difference analysis service module 1570, a facility efficiency analysis service module 1580 and a web server 1590.

The building attribute profile management service module 1510 receives from a manager or generates building attribute information of location, size, purpose, energy source, facilities, and consumption quantity of a building through the system 1000. In an embodiment, a building energy manager may input building attribute information for each building through a control terminal 1800 after requesting the execution of the building attribute profile management service module 1510. The inputted building attribute information may be stored in the building attribute profile information DB 1310.

The demand control/policy management service module 1520 provides a management function to input/modify building energy management policy information of each building, such as energy contract information, energy goal management and comparative earnings, energy source management, hourly load and price setting, peak management and the like to the building energy manager.

The consumption information statistics analysis service module 1530 provides various statistical analyses such as a trend analysis, a consumption quantity analysis, a peak analysis and the like by time/facility (e.g., heater, air conditioner, refrigerator, lighting and the like)/energy source (e.g., coal, natural gas, power energy, renewable energy, oil and the like)/building purpose, and provides analysis result to a real-time energy efficiency improvement device 1700.

The building benchmarking service module 1540 compares attribute information of a building to be benchmarked and energy consumption quantity of the same or different building having similar conditions based on the attribute information (area, size, type, purpose, floor, room, energy source, facilities, energy consumption quantity, energy efficiency and the like) by building stored in the building attribute information DB 1510. The building benchmarking service module 1540 selects the same or different building having similar conditions after the manager selects a benchmarking building and attribute therefor, collects energy consumption quantity of the selected building from the energy consumption quantity information DB 1330, analyzes by generating baseline information and comparing with that of the benchmarking building and provides the result to the real-time energy efficiency improvement inference device 1700.

The consumption factor analysis service module 1550 analyzes correlation between environmental factors (temperature, humidity, brightness, occupancy, precipitation, solar radiation, weather, occupants and the like) which affect energy consumption of each facility of the building. When the manager requests energy consumption factor analysis for a building facility, the consumption factor analysis service module 1550 collects energy consumption quantity information relating to the facility from the energy consumption quantity information DB 1330, operation-related environment information (temperature, humidity, brightness, occupancy) from the environment information DB 1340 and building attribute information such as precipitation, solar radiation, weather, occupants and the like from the building attribute profile information DB 1310 to generate sample data using a data cleansing algorithm and a data discretization algorithm and the like for the collected information. The consumption factor analysis service module 1550 then analyzes correlation between energy consumption quantity, attribute information and environment information using various correlation analysis algorithms such as data mining and the like based on the sample data to provide consumption factor correlations to save energy consumption and improve energy efficiency of the facilities.

The energy consumption prediction service module 1560 predicts energy consumption by a building or a facility which a manager requests to provide predicted quantity information of time series energy consumption by a facility such as building heating, ventilation and air conditioning, refrigerator, lighting and the like which is suitable for environmental conditions at the time to predict by applying a data mining-based energy consumption prediction algorithm and the consumption factor correlation obtained by the consumption factor analysis service module 1550.

The performance/outcome difference analysis service module 1570 analyzes difference between the measured energy consumption information and the energy consumption predicted quantity information predicted by the energy consumption prediction service module 1560 to improve accuracy of consumption prediction.

The facility efficiency analysis service module 1580 analyzes energy efficiency of building facilities by collecting facility information from the building attribute profile information DB 1310 and the energy efficiency factor information measured for a corresponding facility from the real-time commissioning information DB 1350. The facility efficiency analysis service module 1580 generates an energy efficiency baseline of a corresponding facility to analyze efficiency continuously and transmit the result to the real-time energy efficiency improvement plan inference device 1700.

The web server 1590 provides web-based services provided by the service modules (1510 to 1580) to a remote building energy manager.

The building energy consumption analysis service control/management device 1600 manages for executing/deleting/adding/changing the service modules (1510 to 1590) included in the building energy consumption analysis device 1500. The building energy consumption analysis service control/management device 1600 not only can execute a service requested by a manager on a one off base but also consistently.

The real-time energy efficiency improvement inference device 1700 provides a building energy efficiency improvement plan in real time obtained based on the execution result from the service modules (1510 to 1590) included in the building energy consumption analysis device 1500 to a manager. The real-time energy efficiency improvement inference device 1700 generates building energy efficiency status information or efficiency improvement action information according to each service execution result automatically and provides the result to a control terminal 1800.

The efficiency improvement inference device 1700 is an inference engine based expert system which provides efficiency status or improvement plans/actions according to the service result. The efficiency improvement inference device 1700 collects and combines various energy consumption information statistics analysis results from the consumption information statistics analysis service module 1530, energy consumption quantity benchmarking analysis result from the building benchmarking service module 1540, correlation analysis result between environmental factors which affect energy consumption by each facility of a building from the consumption factor analysis service module 1550, time series energy consumption quantity prediction analysis result by a facility such as building heating, ventilation and air conditioning, refrigerator, lighting and the like which is suitable for environmental conditions at the time to predict through an energy consumption factor correlation based energy consumption prediction algorithm from the energy consumption prediction service module 1560, demand prediction analysis result for building facilities and energy sources according to building energy management policies from the demand control/policy management service module 1520, difference analysis result between the measured energy consumption information and the energy consumption predicted quantity information predicted by the energy consumption prediction service module 1560 from the performance/outcome difference analysis service module 1570, energy efficiency analysis result information for building energy facilities from the facility efficiency analysis service module 1580 and the like to generate building energy efficiency status information or efficiency improvement action information automatically based on each service execution result and provides the result to the control terminal 1800.

The efficiency or improvement plan for an individual service which a manager requests may be provided on a one off base but also consistently by executing the service repeatedly. Various efficiency status information and improvement measure information for improving energy efficiency such as peak control according to actual energy consumption quantity change, demand prediction through the consumption information trend analysis, energy savings compared to a similar building, operation based on the building energy consumption factor correlation, demand policy based on the energy consumption prediction result, energy source utilization based on the energy consumption prediction, energy consumption prediction improvement plans based on the outcome analysis, energy efficiency management plans of facilities and the like can be provided in real time to a manager.

The manager control terminal 1800 provides for a building energy manager to select a building for an energy consumption analysis and an energy consumption analysis service among the services provided by the service modules (1510 to 1590) and provides visualized energy efficiency improvement plan information provided from the real-time energy efficiency improvement plan providing device 1700 based on execution result of the selected service module. In an embodiment, the control terminal 1800 can provide energy efficiency improvement plans in a form of text, table, figure, graph and the like by using a graphic user interface function.

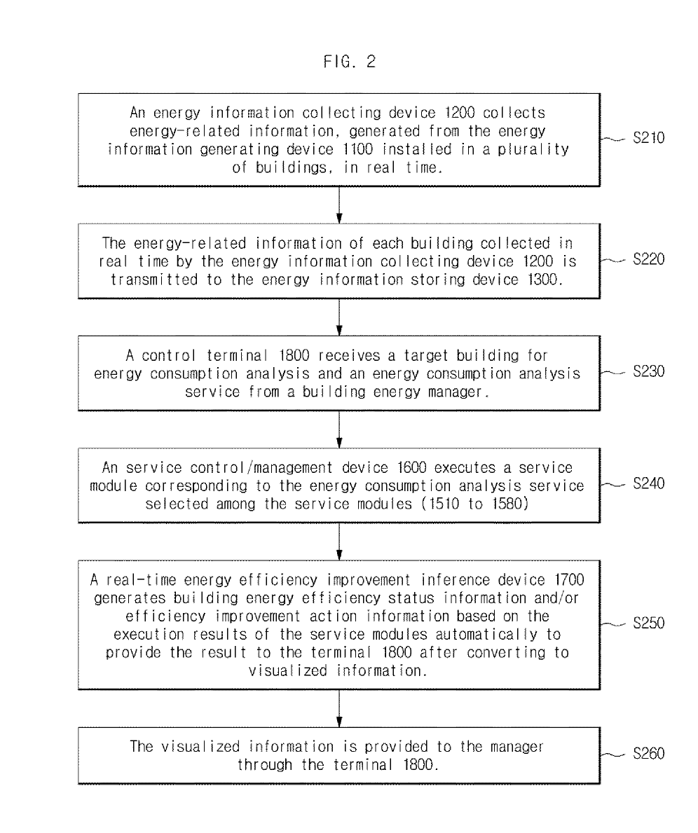

FIG. 2 is a flowchart illustrating a process for providing building energy consumption analysis services according to an embodiment of the present invention.

In S210, the energy information collecting device 1200 collects energy-related information generated from the energy information generating device 1100 which is installed in a plurality of buildings which are monitoring targets in real time.

In S220, the energy-related information of each building collected in real time by the energy information collecting device 1200 is transmitted to the energy information storing device 1300 through internet and the energy information storing device 1300 stores and manages the building energy-related information received from the energy information collecting device 1200 by classifying by type in time series.

In S230, the control terminal 1800 receives a target building for energy consumption analysis and an energy consumption analysis service from a building energy manager. In an embodiment, the control terminal 1800 facilitates selection of a building and an energy consumption analysis service through a graphical user interface. In an embodiment, the energy consumption analysis service may include a building attribute profile management service, a demand control/policy management service, a consumption information statistics analysis service, a building benchmarking service, a consumption factor analysis service, an energy consumption prediction service, a performance outcome difference analysis service and a facility efficiency analysis service.

In S240, the service control/management device 1600 executes a service module corresponding to the energy consumption analysis service selected among the service modules (1510 to 1580) provided from the analysis device 1500. The service module obtains information necessary for the selected energy consumption analysis service of the building from the energy information storing device 1300 through the DB interface device 1400. The service module selected by a manager according to a manager's service selection mode can be automatically executed once or repeatedly to provide the result once or consistently.

In S250, the real-time energy efficiency improvement inference device 1700 generates building energy efficiency status information and/or efficiency improvement action information based on the execution results of the service modules (1510 to 1580) automatically to provide the result to the control terminal 1800. The efficiency improvement inference device 1700 is an inference engine based expert system which provides efficiency status or improvement plans according to the service results.

For example, action (plan) information according to the energy consumption quantity difference can be provided to the manager based on the execution result of the building benchmarking service module 1540.

Various actions (plans) such as abnormality status and alarm according to degree of difference by comparing with efficiency baseline of the facility based on the execution result of the facility efficiency analysis service module 1580 can be also provided.

Various actions (plans) according to at least one energy consumption factor and weight thereof can be also provided based on the execution result of the consumption factor analysis service module 1550.

Various actions (plans) such as selection of an energy source and an operation method can be also provided based on the execution results of the energy consumption prediction service module 1560 and the demand control/policy management module 1520.

Error in a measured value can be checked or action to complement energy consumption prediction can be provided based on the execution results of the performance/outcome difference analysis service module 1570.

In S260, building energy efficiency status information and/or energy efficiency improvement measure information provided from the real-time energy efficiency improvement inference device 1700 can be visualized into various forms such as graphs, diagrams and the like and sent to the manager through the control terminal 1800.

The system and method of the present invention may be recorded in a computer readable medium by being implemented by any language among various appropriate programming languages which can be executed through various computer means.

The computer readable medium can include program instructions, data files, data structures and the like alone or in a combination.

The program instruction recorded in the computer readable medium can be specially designed for the present invention or available to those who are skilled in the computer software field. An example of the computer readable recording media includes magnetic recording media such as hard disks, floppy disks and magnetic tapes, optical media such as CD-ROMs and DVDs, magneto-optical media such as floptical disks and hardware devices such as a ROM, a RAM, a flash memory and the like which are configured to store and perform program instructions. The above-mentioned medium may be a transmission medium such as optical or metallic lines and waveguides including a carrier which transmits signals to assign program instructions, data structures and the like. An example of the program instruction may include not only machine-language codes which are made by a compiler but also high-level language codes which are executable by a device such as a computer processing information electronically by using an interpreter and the like.

The hardware device above mentioned may be configured to perform operations of the present invention as one or more software modules and vice versa.

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. A system for analyzing building energy consumption comprising:
a building energy information generating device generating building energy-related information by being installed in each of a plurality of buildings which are to be controlled;
a building energy information collecting device collecting the energy-related information generated by the building energy information generating device in real-time;
an energy information storing device receiving building attribute information and the building energy-related information collected by the building energy information collecting device and storing it on a building and information type basis;
an energy consumption analysis service device providing an energy consumption analysis service based on the building energy-related information and the building attribute information stored in the energy information storing device; and
a real-time energy efficiency plan providing device providing an energy efficiency improvement plan for the building in real-time based on the energy consumption analysis service result.

2. The system for analyzing building energy consumption of claim 1, further comprising a control terminal receiving a request for the energy consumption analysis service from a manager and displaying a corresponding service result to the manager.

3. The system for analyzing building energy consumption of claim 1, wherein the building energy information storing device includes a building attribute profile information DB, a HVAC facility operation/status information DB, an energy consumption quantity information DB, an environment information DB and a real-time commissioning information DB.

4. The system for analyzing building energy consumption of claim 1, wherein the energy consumption analysis service device comprises at least one of a building attribute profile management service module, a demand control/policy management service module, a consumption information statistics analysis service module, a building benchmarking service module, a consumption factor analysis service module, an energy consumption prediction service module, a performance outcome difference analysis service module, a facility efficiency analysis service module and a web server.

5. The system for analyzing building energy consumption of claim 4, further comprising, when a request selected from a building attribute profile management service, a demand control/policy management service, a consumption information statistics analysis service, a building benchmarking service, a consumption factor analysis service, an energy consumption prediction service, a performance/outcome difference analysis service and a facility efficiency analysis service is inputted from the building energy manager, the energy consumption analysis service device selects a service module corresponding to the requested service, among the service modules of the energy consumption analysis service device, and performs for addition, deletion or change for the service modules.

6. The system for analyzing building energy consumption of claim 1, wherein the building energy information generating device comprises energy consumption facilities including heating, ventilation and air conditioning (HVAC) and lighting of the building, an energy meter and an environment sensor.

7. The system for analyzing building energy consumption of claim 6, wherein the energy-related information collected by the building energy information collecting device comprises operation/status information of the energy consumption facilities, energy metering information measured by the energy meter and environment sensor information determined by the environment sensor.

8. The system for analyzing building energy consumption of claim 1, wherein the building attribute information comprises at least one of location, size, purpose, energy source, facility information and energy consumption quantity information of the building.
